(19) United States
(12) Patent Application Publication
(10) Pub. No.: US 2007/0208459 A1
(43) Pub. Date: Sep. 6, 2007

(54) Sentry robot

(75) Inventor: Keun-kug Choi, Changwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/711,308

(22) Filed: Feb. 27, 2007

(30) Foreign Application Priority Data
Mar. 3, 2006 (KR) 10-2006-0020409

(51) Int. Cl. G06F 19/00

(52) U.S. Cl. 700/245

(57) ABSTRACT

A monitoring and sentry robot which can perform wide and narrow monitoring in short and long ranges and can automatically shoot at a target. The sentry robot includes a base, a main body installed on the base capable of pivoting, a master camera capable of rotating with the main body, and an active camera arranged on the main body capable of rotating in left and right directions and up and down directions with respect to the main body.

### CROSS-REFERENCE TO RELATED PATENT APPLICATIONS

This application claims the benefit of Korean Patent Application No. 10-2006-0020409, filed on Mar. 3, 2006, in the Korean Intellectual Property Office, the disclosure of which is incorporated herein in its entirety by reference.

### BACKGROUND OF THE INVENTION

1. Field of the Invention

The present invention relates to a sentry robot, and more particularly, to a sentry robot capable of performing wide and narrow monitoring in short and long ranges and automatically shooting at a target.

2. Description of the Related Art

Intelligent robot technology is one of the next generation new technologies which will lead the 21^{st} century's industrial and military science technologies with the technical development of artificial intelligence (AI). In particular, a monitoring and sentry system is a sophisticated system employing a variety of technologies such as ultra-low brightness camera technology, image recognition technology, image processing and storing technology, voice recognition technology, servo technology, image tracking technology, and system control technology.

As the security industry grows rapidly, demands for the use of intelligent monitoring and sentry robot systems in important national facilities, such as airports, harbors, and nuclear power plants, have increased accordingly. In particular, such a system becomes desired by the military to enhance efficiency of sentry in peace time. To improve the security of soldiers and efficiency in war time, various unmanned equipment which can replace the 3D (dangerous, dirty, dull) duties of soldiers have been developed and employed. The unmanned robot based on AI technology can efficiently replace manpower and greatly contribute to the enhancement of military competitive power.

In particular, the monitoring and sentry robot can perform important role in the development of the military strategy. Also, in terms of monitoring and sentry, robots are not susceptible to fatigue and lowering of concentration due to repetition of a simple work by soldiers on sentry duty. Furthermore, when provided with weapons, the system can have accurate tracking and instant reaction abilities including high speed and accurate shooting ability especially effective during war time.

U.S. Pat. No. 5,379,676 entitled “Fire Control System” discloses a shooting control system for a manually aimed gun. In the patent, a target is tracked by a video tracker and laser of an electro-optical device (EOD) and the distance and direction of the target are calculated. A target image is sent to a video monitor of an operator and the operator performs shooting by controlling the gun to match the target through the video monitor.

However, the shooting control system has a problem in that the range of monitoring by a camera device of the system is limited. Also, the conventional monitoring and sentry system employing a single video camera or common monitoring camera is a basic system adopting the concept of automation, not a system capable of intelligently recognizing a target and automatically tracking the target.

### SUMMARY OF THE INVENTION

To solve the above and/or other problems, the present invention provides a monitoring and sentry robot which can perform wide and narrow monitoring in short and long ranges and which can automatically shoot at a target.

According to an aspect of the present invention, a sentry robot comprises a base, a main body pivotally installed on the base, a master camera capable of rotating with the main body, and an active camera arranged on the main body capable of rotating left and right and up and down with respect to the main body.

The master camera comprises two cameras, each installed at a side of the main body.

A frame protruding forward and capable of rotating left and right with the main body is installed at the main body and the master camera is installed capable of rotating left and right and up and down on the frame.

The sentry robot may also include a gun installed on the main body with the active camera pointing in a direction pointed by the active camera and capable of moving with the active camera while tracking a target.

The sentry robot further comprises a driving portion driving movements of the main body, the master camera, the active camera, and the gun and a control portion controlling shooting of the gun to perform functions of image analysis, target recognition, and target tracking by controlling the driving portion.

The sentry robot further comprises a base connection portion supporting the main body and connected to the base, a main body connection portion installed capable of rotating in the left and right directions on the base connection portion, a pivot ring gear fixed to the base connection portion, a pivot drive gear engaged with the pivot ring gear and fixed to the main body connection portion, a pivot drive motor driving the pivot drive gear, a master camera rotation shaft arranged capable of rotating at the main body connection portion, a master camera connection portion installed at both sides of the master camera rotation shaft, and a motor rotating the master camera rotation shaft.

### BRIEF DESCRIPTION OF THE DRAWINGS

The above and other features and advantages of the present invention will become more apparent by describing in detail preferred embodiments thereof with reference to the attached drawings in which:

FIG. 1 is a perspective view schematically showing the structure of a sentry robot according to an embodiment of the present invention;

FIG. 2 is a side view of the sentry robot of FIG. 1;

FIG. 3 is a perspective view of the sentry robot shown in FIGS. 1 and 2 in which an armor encompassing a main body and a driving portion of an image monitoring portion including a master camera is disassembled;

FIG. 4 is a perspective view of the sentry robot shown in FIGS. 1 and 2, showing the structure of the main body and the driving portion of the image monitoring portion including the master camera is disassembled;

FIGS. 5 through 7 illustrate the monitoring area of the sentry robot according to the present invention;

FIG. 8 is a perspective view schematically showing the structure of a sentry robot according to another embodiment of the present invention; and

FIG. 9 is a side view of the sentry robot of FIG. 8.

### DETAILED DESCRIPTION OF THE INVENTION

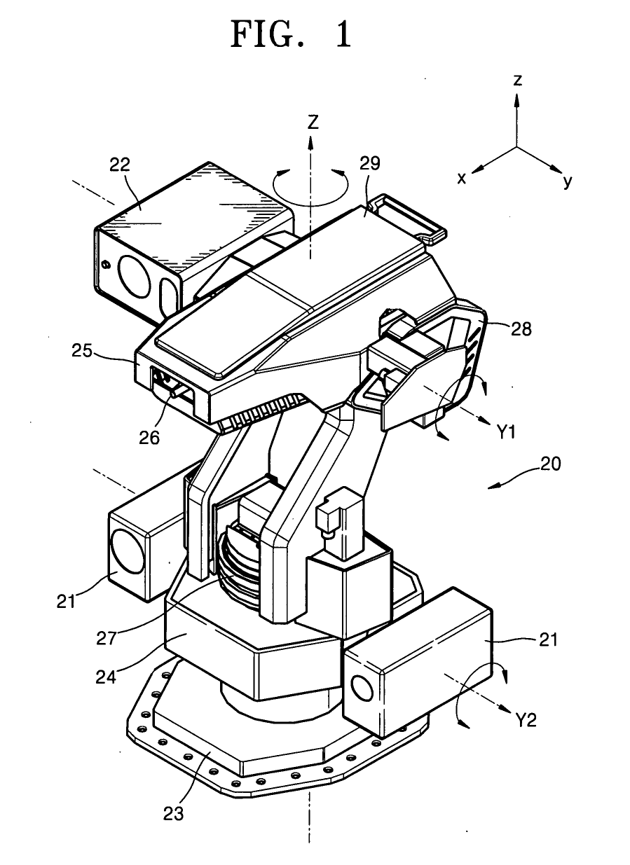

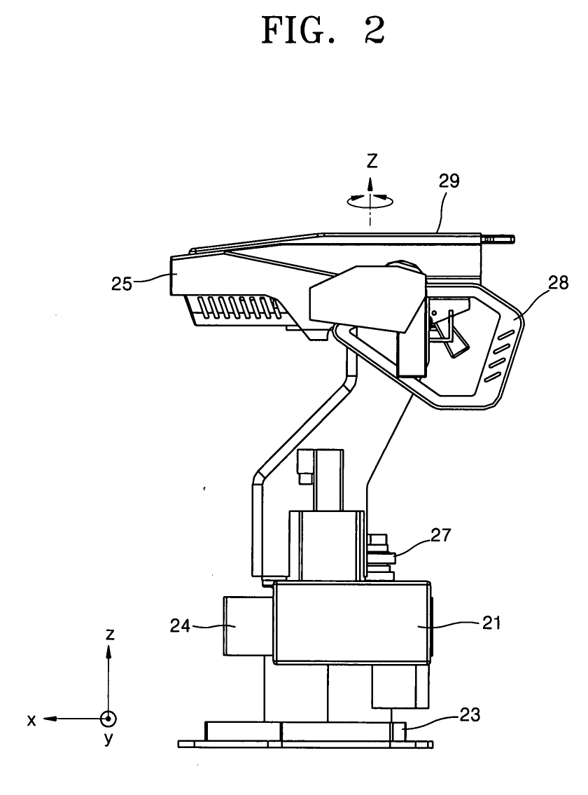

Referring to FIGS. 1 and 2, a sentry robot 20 according to an embodiment of the present invention includes a base 23, an image monitoring portion, and an image tracking portion.

The base 23 is a member for fixedly installing the sentry robot 20 at a particular position or to a device. The image monitoring portion includes a main body 24 arranged on the base 23, a master camera 21 and an image monitoring portion driving portion. The image monitoring portion driving mechanism will be described in detail later. The image tracking portion includes an active camera 22 arranged on the main body 24, a gun 26, and an image tracking portion driving mechanism 27.

The sentry robot 20 is operated by two types of cameras, that is, the master camera 21 and the active camera 22. The sentry robot 20 receives information on the movement of a target from each of the cameras and performs tracking for monitoring and sentry so that a tracking rate and a recognition rate are improved.

The main body 24 is capable of rotating to the left and right sides (panning) around a z axis on the base 23. The master camera 21 and the active camera 22 are installed on the main body 24. The gun 26 is installed with the active camera 22, as necessary. Armor may be provided to protect the robot from bullets or debris and is preferably installed outside the main body 24.

The master camera 21 is installed on the main body 24, or at both sides of the main body 24 as shown in the drawings, and recognizes a target from an input image. The master camera 21 is rotatable around a y2 axis in a vertical direction with respect to the main body 24. The active camera 22 is provided on the main body 24. The active camera 22 is installed capable of tilting and panning with respect to the main body 24 and tracking the target.

The gun 26 capable of shooting bullets or other armaments automatically or manually toward an enemy is arranged in the upper portion of the main body 24 in addition to the active camera 22. Also, the image tracking mechanism driving portion 27 which allows the active camera 22 and the gun 26 to move while tracking the target is installed in the upper portion of the main body 24.

The image tracking portion driving mechanism 27 can rotate the active camera 22 and the gun 26 to the left and right sides around the z axis and simultaneously up and down around an y1 axis with respect to the main body 24. A shooting driving mechanism (not shown) capable of allowing the gun 26 to shoot automatically or remotely and manually is installed at the gun 26.

The sentry robot 20 according to the present embodiment may further include a control portion (not shown). The control portion receives an image from the master camera 21 and the active camera 22, recognizes the received image, and controls the operation of the master camera 21, the active camera 22, and the image tracking portion driving mechanism 27. The control portion can be installed inside the main body 24.

Gun armor 25 is preferably installed outside the gun 26 of the robot 20 to protect the gun 26 from bullets or other debris. The gun armor 25 preferably includes a gun cover 29 which can be open and close by an operator to check the state of the gun 26. Also, a gun manual control handle 28 can be further installed to directly control the gun 26 by the operator as necessary.

It is preferable that the gun barrel of the gun 26 is generally parallel to the optical axis of the active camera 22 so that the direction of the gunbarrel of the gun 26 pointing to a target matches the direction of the active camera 22. The master camera 21 and the active camera 22 are preferably ultra-low brightness cameras having an infrared block filter blocking input of an image in an infrared area. The master camera 21 and the active camera 22 can receive a color image by turning on the infrared block filter during the day time and a black and white image by turning off the infrared block filter during the night time. Accordingly, the master camera 21 and the active camera 22 can receive an image during the day time and the night time using the ultra-low brightness camera.

The master camera 21 preferably has a wider viewing angle than the active camera 22. That is, the master camera 21 with a wider viewing angle performs a function of detecting an overall movement in a main viewing range. The master camera 21 has a zoom function and is set by adjusting a magnification ratio according to conditions in use such as observation distance and range. The master camera 21 recognizes a target by acquiring an image from a wide area in the main viewing range and detects an overall movement of the target.

The active camera 22 is controlled to be moved according to the information on the movement of a target recognized by the master camera 21 so that the optical axis of the active camera 22 is directed to the center of the target. Also, the active camera 22 more accurately detects information such as the speed, displacement, and size of a target that moves, maintaining a higher resolution compared to the master camera 21.

For this purpose, the active camera 22 has functions of zooming, panning, and tilting. The panning and tilting functions of the active camera 22 enable the optical axis of the active camera 22 to always point at the center of the target. Also, the image of the target can be enlarged by the zooming function of the active camera 22 so that the target can be observed in more detail.

Accordingly, given that the target has a certain size, since the direction of the gun barrel of the gun 26 is generally aligned with the axis of the active camera 22, the gun barrel of the gun 26 points at the target.

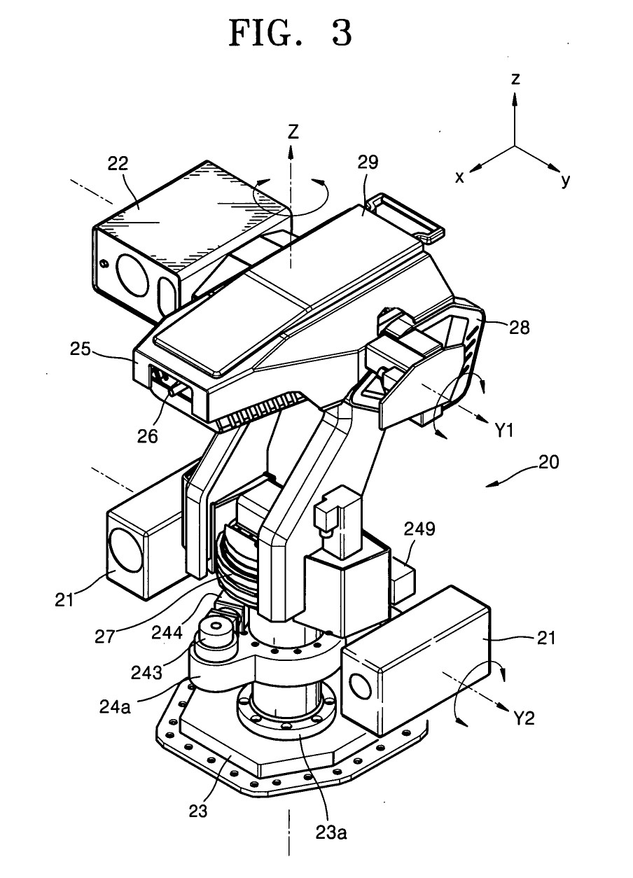

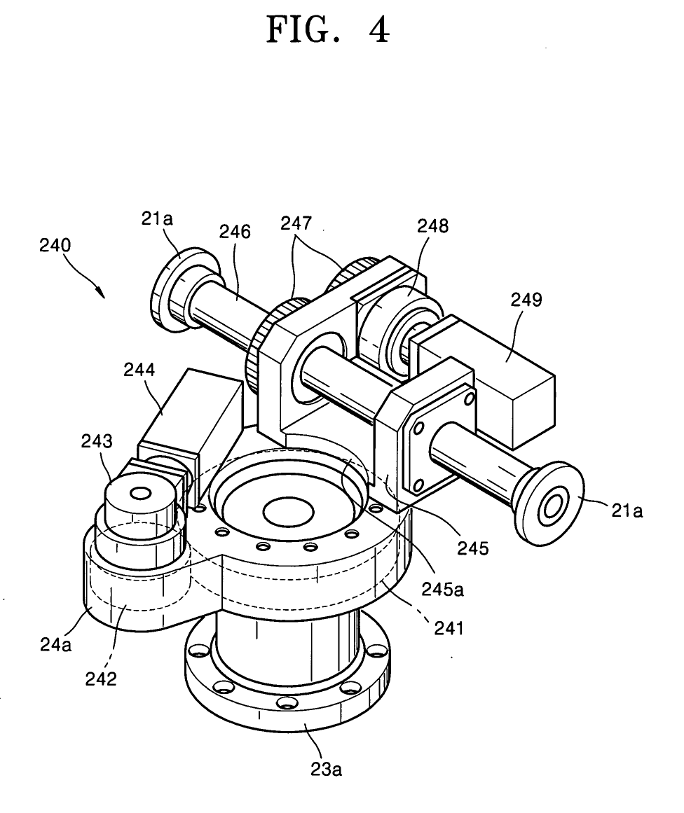

As shown in FIGS. 3 and 4, the image monitoring portion driving mechanism 240 has a structure that enables panning and tilting. That is, the image monitoring portion driving mechanism 240 includes a base connection portion 23a so it is capable, a main body connection portion 24a, and a master camera rotation axis 246.

The main body connection portion 24a supports the main body 24 and the base connection portion 23a supports the base 23. The main body connection portion 24a is installed on the base connection portion 23a so that it is capable of panning. A pivot ring gear 241 fixed at the base connection portion 23a and a pivot drive gear 242 engaged with the pivot ring gear 241 and fixed at the main body connection portion 24a are installed on the base connection portion 23a. The pivot driving gear 242 is rotated by a pivot drive motor 244 so that the main body connection portion 24a pivots on the base connection portion 23a. A decelerator 243 can be installed between a rotation shaft of the pivot drive gear 242 and a rotation shaft (not shown) of the pivot drive motor 244.

The master camera rotation shaft 246 is rotatably installed on the main body connection portion 24a. A master camera connection portion 21a is, installed at both sides of the master camera rotation shaft 246. The master camera rotation shaft 246 is connected to a motor 249 by a power transfer means 247 such as a gear and is rotated by the motor 249. The master camera 21 connected to the master camera rotation shaft 246 is capable of tilting by the rotation of the motor 249. A decelerator 248 can be further installed between a rotation shaft (not shown) of the motor 249 and the master camera rotation shaft 246.

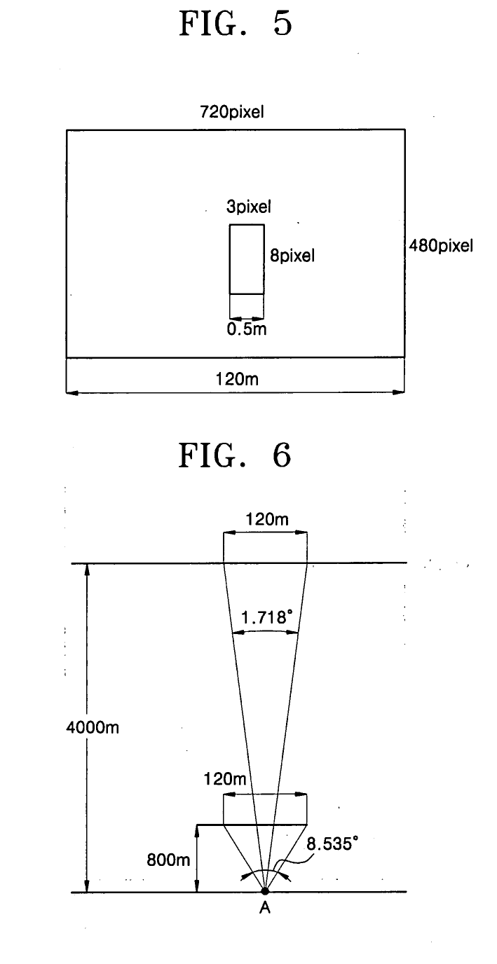

The sentry robot configured as above can be operated in the following method. FIGS. 5 through 7 illustrate the operation range of the image monitoring portion of the sentry robot to detect a target in the sentry range. The image monitoring portion refers to the lower portion of the sentry robot including the master camera and the driving portion for driving the master camera. In particular, the image monitoring portion includes the image monitoring portion driving mechanism 240 of the main body that affects the panning and tilting motion of the master camera.

As shown in FIG. 5, when a range having a width of 120 m at a predetermined distance is detected using a camera having 720×480 pixels, the number of pixels needed to recognize a target having a human size of about 0.5 m wide and 1.5 m high is the minimum of 3×8 pixels.

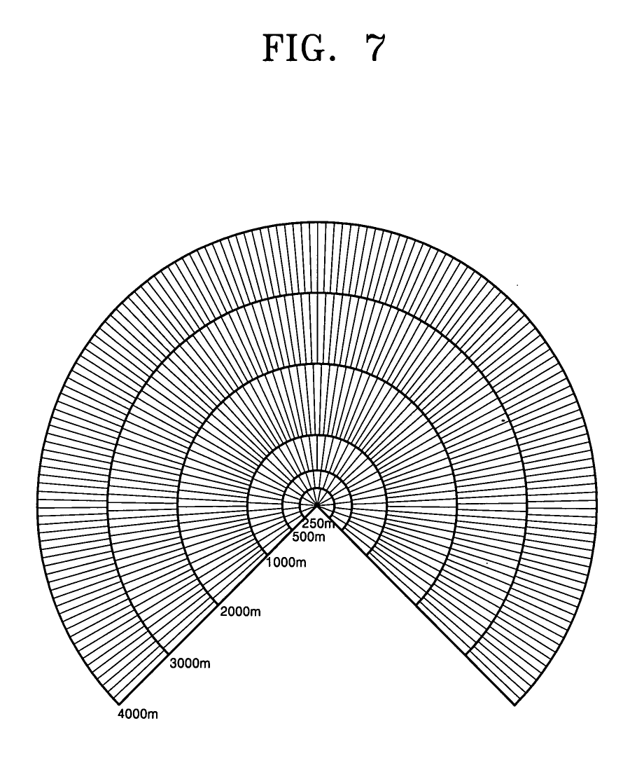

FIG. 6 illustrates the angle of view of a camera according to the distance. For example, to recognize a range of 120 m wide at a distance of 800 m in a single screen, an angle of view is about 8.5350. Also, to recognize a range of 120 m wide at a distance of 4000 m in a single screen, an angle of view is about 1.7180.

Considering the angle of view as shown in FIG. 6, in order to monitor a range of 2700 at a distance of 4 km in a single screen, assuming that a range having a width of 120 m is observed at a time, a monitoring section can be divided into a total of 427 units as shown in Table 1.

TABLE 1

| | Section | Number of | |
|---|---|---|---|
| Target Distance | Monitoring | Monitoring | |
| (m) | Angle (°) | Sections (unit) | Monitoring Range (m) |
| 4000 | 1.718 | 158 | 120 × 2216 (1784~4000) |
| 3000 | 2.301 | 118 | 120 × 1800 (1200~3000) |
| 2000 | 3.435 | 79 | 120 × 1309 (691~2000) |
| 1000 | 6.846 | 40 | 120 × 720 (279~1000) |
| 500 | 13.502 | 21 | 120 × 474 (26~500) |
| 250 | 24.546 | 11 | 120 × 243 (6.7~250) |

| | |
|---|---|
| Total | 427 |

In Table 1, for example, when the target distance is 4000 m, the section monitoring angle is 1.718°. When the range of 270° is divided by 1.718°, the number of monitoring sections required is 158 at a minimum. The area of each of the monitoring sections is 120 m wide so that a range of 2216 m in a direction parallel to a direction in which the camera points can be monitored in a single screen. That is, an area that is separated from the camera at a distance from 1784 m to 4000 m is monitored in a single screen.

FIG. 7 illustrates the section monitoring angle based on the contents listed in Table 1. The area in FIG. 7 is divided into a total of 427 areas in a range of 2700. The sentry robot according to the present embodiment can control the motion of the image monitoring portion in the left and right direction and in the up and down direction to all of the 427 areas in order or monitor an arbitrary area as necessary.

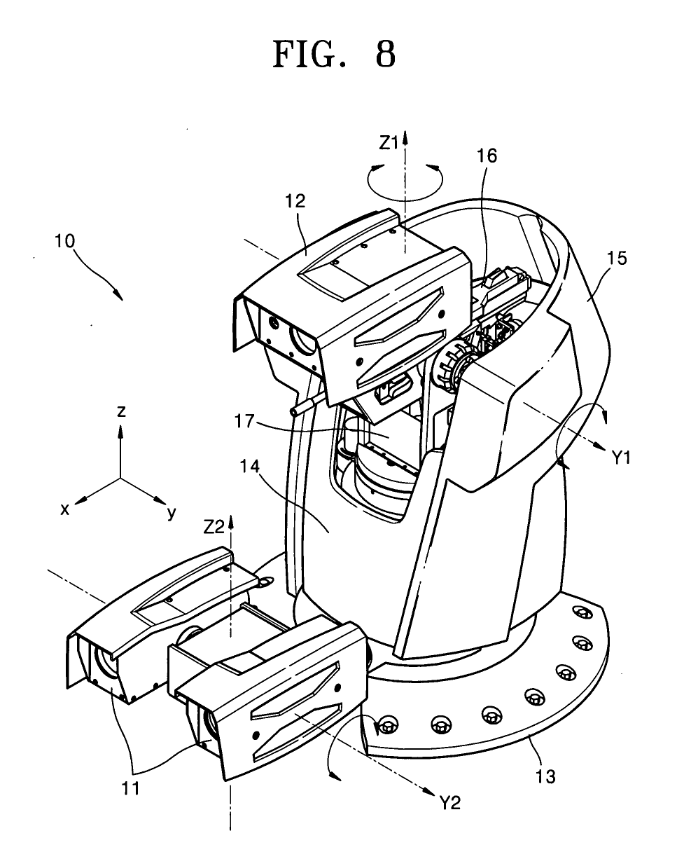

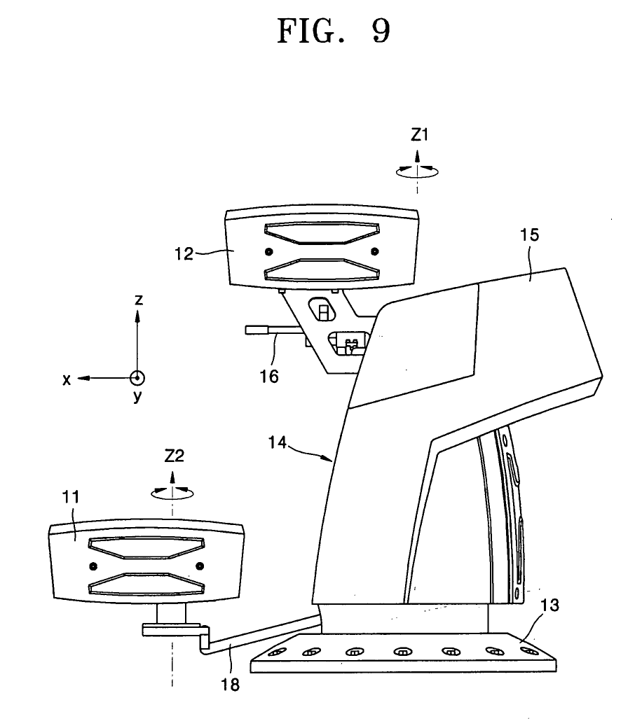

Referring to FIGS. 8 and 9, a sentry robot 10 according to another embodiment of the present invention includes a base 13, a main body 14, a master camera 11, and an active camera 12. The sentry robot 10 is operated by two types of cameras, that is, the master camera 11 and the active camera 12. The sentry robot 10 receives information on the movement of a target from each of the cameras and performs monitoring and tracking for sentry so that a tracking rate and a recognition rate are improved. In the present embodiment, the master camera 11 is arranged to protrude forward from the main body 14.

The master camera 11 is connected to the main body 14 by a frame 18 and recognizes a target from an input image. The main body 14 is rotatable on the base 13 to the left and right directions around a z1 axis. Accordingly, the frame 18 and the master camera 11 can pivot in the left and right directions around the z1 axis. Also, the master camera 11 is installed capable of rotating in the left and right directions around a z2 axis and in the up and down directions around a y2 axis with respect to the frame 18.

The active camera 12 is capable of rotating in the left and right directions around a z1 axis and in the up and down directions around a y1 axis with respect to the main body 14. The active camera 12 can be installed with a gun 16 as shown in FIGS. 8 and 9. In this case, the active camera 12 and the gun 16 are arranged on parallel axes so that they are capable of rotating in the up/down and left/right directions on the main body 14 while tracking a target.

Preferably, armor 15 is installed on the outer side of the robot 10 to protect the robot 10 from bullets or debris. A shooting driving portion (not shown) enabling automatic or remote manual shooting of the gun 16 is installed on the gun 16.

The sentry robot 10 may further include a control portion (not shown). The control portion receives an image from the master camera 11 and the active camera 12, recognizes the received image, and controls the operations of the master camera 11, the active camera 12, and a driving portion 17. The control portion can be installed inside the main body 14.

As described above, the sentry robot according to the present invention can recognize the shape and movement of a target at a short or long distance. Also, a target moving at short and/or long distances can be effectively tracked and automatic shooting at the target is possible. In particular, compared to the conventional sentry robot, tracking of the target in a much wider area is possible.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A sentry robot comprising:
a base;
a main body pivotally installed on the base;
a master camera capable of rotating with the main body; and
an active camera arranged on the main body capable of rotating in left and right directions and up and down directions with respect to the main body.

2. The sentry robot of claim 1, wherein the master camera comprises two cameras, installed at either side of the main body.

3. The sentry robot of claim 1, further comprising a frame protruding forward and attached to the main body and the master camera is installed on the frame and is rotatable in the left and right directions and up and down directions on the frame.

4. The sentry robot of claim 1, further comprising a gun installed on the main body with an axis generally parallel to the active camera and moves with the active camera while tracking a target.

5. The sentry robot of claim 4, further comprising:
a driving portion driving movements of the main body, the master camera, the active camera, and the gun; and
a control portion controlling shooting of the gun to perform, functions of image analysis, target recognition, and target tracking by controlling the driving portion.

6. The sentry robot of claim 1, further comprising:
a base connection portion supporting the main body and connected to the base;
a main body connection portion installed on the base connection portion and which of rotates in the left and right directions with respect to the base connection portion;
a pivot ring gear fixed to the base connection portion;
a pivot drive gear engaged with the pivot ring gear and fixed to the main body connection portion;
a pivot drive motor driving the pivot drive gear;
a master camera rotation shaft arranged capable of rotating at the main body connection portion;
a master camera connection portion installed at both sides of the master camera rotation shaft; and
a motor rotating the master camera rotation shaft.

7. A sentry robot comprising:
a target monitoring system comprising a main body and a monitoring optical sensor arranged for tilting and panning movement with respect to the main body,
a target tracking system comprising a tracking optical sensor arranged for tilting and panning movement independent of the movement of the monitoring optical system,
a target tracking control system for controlling the movement, of the tracking optical sensor in response to information received from the target monitoring system.

8. The sentry robot of claim 7 further comprising a gun which is substantially aligned with the axis of the tracking optical system.

9. The sentry robot of claim 8 where the target tracking control system controls the movement of the tracking optical system to keep the gun generally pointing at a target monitored by the target monitoring system.

10. The sentry robot of claim 7 wherein the monitoring optical sensor comprises a pair of cameras mounted on either side of the main body.

11. The sentry robot of claim 7 further comprising armor disposed on the main, body.

12. The sentry robot of claim 7 further comprising a zooming system for magnifying the monitoring optical sensor.

13. The sentry robot of claim 7 wherein the monitoring optical sensor and the tracking optical sensor are ultra-low brightness cameras.
